(19) United States
(12) Patent Application Publication
(10) Pub. No.: US 2012/0249316 A1
(43) Pub. Date: Oct. 4, 2012

(54) BICYCLE BRAKE LIGHT SYSTEM

(75) Inventors: Stuart Morrow, Taipei City (TW); Hung-Chih Wang, Kaohsiung City (TW)

(73) Assignee: LITE-ON TECHNOLOGY CORPORATION, TAIPEI CITY (TW)

(21) Appl. No.: 13/078,076

(22) Filed: Apr. 1, 2011

(51) Int. Cl. B62J 6/04

(52) U.S. Cl. 340/432

(57) ABSTRACT

A self sustaining brake light system particularly suitable for employment on a bicycle is provided. The brake light system comprises a brake arm operably disposed on a bicycle frame, a power generating unit mounted on the brake arm, and a brake light unit powered by the power generating unit. Particularly, the power generating unit includes a rolling member for establishing frictional contact with the wheel. The power generating unit is adjustably mounted on the brake arm in a pivotal manner. The brake light unit includes at least one light module, and is preferably arranged integrally on the brake arm in a conformal fashion.

### BACKGROUND OF THE INVENTION

1. Field of the Invention

The instant disclosure relates to bicycle brake light system, and pertains particularly to a self-powered conformal brake light system for bicycle.

2. Description of Related Art

Visual signaling devices have been widely employed on motor vehicles to increase visibility thereof and thereby enhance safety. Electrical lighting devices, in particular, are effective sources of visual signal. Numerous types of lighting equipment have been developed and implemented on motor vehicles with little trouble because motor vehicles usually include onboard power generators that can provide necessary power to the lighting devices. In contrast, human-powered vehicles, such as pedal-driven bicycles or tricycles, often do not comprise onboard electricity generating equipment. Therefore, traditionally, these vehicles rely heavily on light reflective elements as their precautious signaling device. However, as these environmentally friendly means of transportation share the roads with other motor vehicles, the safety of their operators and passengers will be greatly enhanced by adequate onboard active lighting devices.

A brake light is one of the most essential types of safety signal. It signals a driver's intention to decelerate as the vehicle's brake system is engaged. Conventional bicycle brake light designs often involve direct placement of switch actuators on the brake shoe, as disclosed by U.S. Pat. No. 3,878,387 to Kovacic. Newer designs incorporate brake cable activated micro-switches for engaging the brake lights. U.S. Pat. No. 5,739,750 to Drake and U.S. Pat. No. 4,833,444 to Wisniewski are iconic examples for such brake light designs. While the conventional designs intuitively utilize the change in brake cable tension or the movement of the brake shoe as the source for actuating brake light switches, the primitive actuating arrangements often cannot compensate for the wear and tear of the brake system, therefore making it difficult to maintain the brake light system in optimal operating status. Moreover, most conventional brake light systems require self-contained power supplies (in most cases dry cell batteries). Thus, careful monitoring of the battery level becomes imperative for ensuring proper operation of the conventional brake light devices.

China Patent CN200820239332.5 to Tao discloses a self-powered bicycle brake light arrangement. Specifically, Tao teaches a power generator driven by a set of gears attached to the brake shoe of the bicycle brake. However, skilled artisans would easily recognize the structural weakness and operation impracticality of this arrangement. Moreover, the exposed power generator not only negatively impacts the aesthetic outlook of the unit but also renders the unit vulnerable to surrounding hazards, such as dust, mud, or water.

Therefore, there remains a need for a self-sustaining, structurally reliable, and aesthetically appealing brake light system particularly suitable for employment on a human powered vehicle.

### SUMMARY OF THE INVENTION

One object of the instant disclosure is to provide a self sustaining brake light system. The brake light system in accordance with the instant disclosure is particularly suitable for employment on a pedal-driven vehicle having a frame and at least two wheels. The brake light system comprises a brake arm mounted on the frame, a power generating unit mounted on the brake arm, and a brake light unit powered by the power generating unit. Particularly, the power generating unit includes a rolling member for establishing frictional contact with the wheel. The power generating unit is adjustably mounted on the brake arm in a pivotable manner. The brake light unit includes at least one lighting module, and is preferably arranged integrally on the brake arm in a conformal fashion.

Another object of the instant disclosure is to provide a brake light system suitable for adapting on an arm portion of a bicycle brake system. The brake light system in accordance with the instant disclosure comprises a mounting mechanism for secure adaptation to the arm portion of the brake system, a power generating unit mounted on the mounting mechanism including a rolling member for establishing frictional contact with a wheel of the bicycle, and a brake light unit powered by the power generating unit. Particularly, the power generating unit is adjustably mounted on the mounting mechanism in a pivotable manner. The brake light unit includes at least one lighting module, and is preferably arranged integrally on the arm portion of the brake system in a conformal fashion.

In order to further the understanding regarding the present invention, the following embodiments are provided along with illustrations to facilitate the disclosure of the present invention.

### BRIEF DESCRIPTION OF THE DRAWINGS

FIG. 1 shows a perspective diagram of one embodiment of the brake light system in accordance with the instant disclosure.

FIG. 2 shows a perspective diagram of one embodiment of the brake light system in accordance with the instant disclosure installed on a frame of a bicycle.

FIG. 3 shows an exploded diagram of one embodiment of the brake light system in accordance with the instant disclosure with the power generating unit detached;

FIG. 4 shows a partially exploded diagram of one embodiment of the brake light system in accordance with the instant disclosure with the power generating unit mounted in place;

FIG. 5 shows a graphical illustration of the actuation and the activation of the brake light system in accordance with the instant disclosure.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

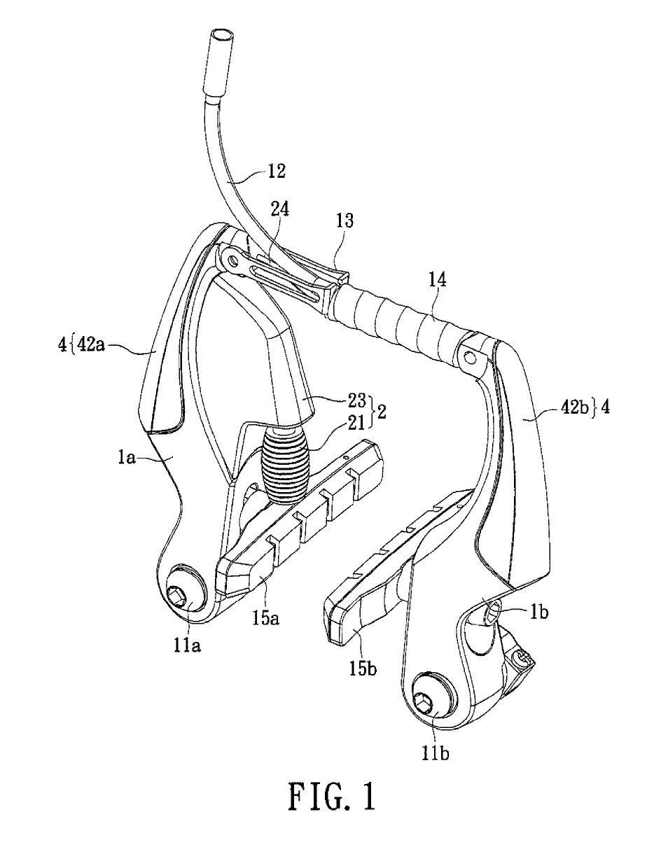

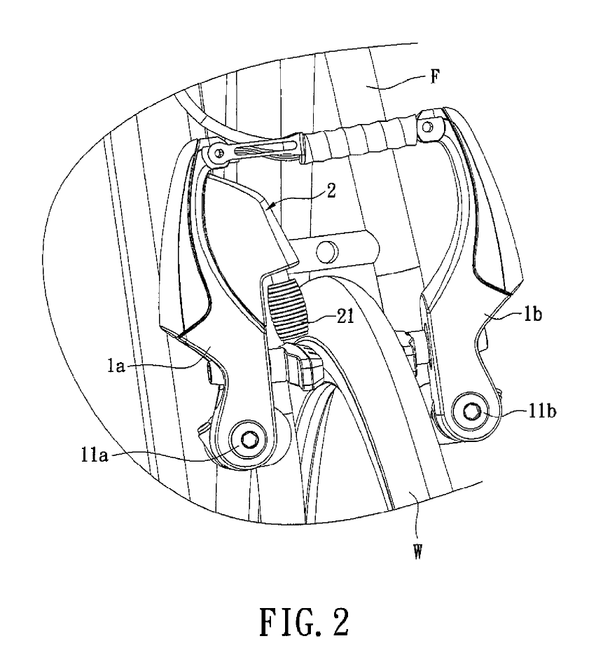

Please refer to FIGS. 1 and 2. FIG. 1 shows a perspective overview of the brake light system in accordance with the instant disclosure, while FIG. 2 illustrates a perspective diagram of the instant brake light system installed on a pedal-driven vehicle, such as a bicycle. Please note that, in order to provide a clearer view of the instant brake light system, FIG. 2 shows only a portion of the bicycle frame F and one wheel W. As an exemplary embodiment, the instant brake light system is shown to be adapted to a popular type of direct-pull cantilever brake system that includes a pair of separate brake arms 1a, 1b. This type of brake system, known as the V-brake® is advantageous for its employment of longer cantilever arms that can provide greater leverage and its relatively simple brake engaging mechanism, which requires only a single cable to pull both brake arms.

Each brake arm 1a/1b is pivotally mounted on the bicycle frame F by a pivot bolt 11a/11b, respectively. A brake cable 12 (such as Bowden cable) is provided to transmit force from a brake lever exerted by the operator of the vehicle. The bent rigid housing of the brake cable 12 (known as “noodle”) is securely secured to an arm link 13 attached to one of the brake arms 1a, while the inner cable of the brake cable is anchored to the other brake arm 1b. A flexible bellows 14 known as the “boot” is provided to cover the exposed inner cable. A pair of Brake shoes 15a, 15b is respectively arranged on the brake arms 1a, 1b in alignment with the proper portions of the wheel W. It is worth noting that, although the instant brake light system is shown to be employed on the direct-pull cantilever brake, a person skilled in the art would recognized that, the instant disclosure would be equally suitable for adaptation on other types of brake designs, given that the subject brake system utilize brake arms of sufficient length and clearance. For one thing, the instant brake system may be suitable for being adapted on an arm portion of a caliper type brake system.

The instant brake light system comprises a power generating unit 2 mounted on the brake arm 1a of a bicycle brake system and a light unit 4 powered by the power generating unit 2. The power generating unit 2 includes a rolling member 21 that can establish frictional contact with the bicycle wheel W through the actuation of the brake arm 1a to harness kinetic energy of the spinning bicycle wheel, thereby powering the light unit 4. Particularly, the rolling member 21 of the power generating unit 2 is arranged with sufficient clearance from the wheel of the bicycle when the brake system is not engaged. As the brake arms 1a, 1b move toward the rim of the bicycle wheel as a result of the actuation of the brake system, the rolling member 21 of the power generating unit 2 mounted thereon (and thus movable there-with) establishes frictional contact with a portion of the bicycle wheel W (such as the sidewall of the wheel). Therefore, when the brake system is activated in the process of decelerating a moving vehicle, friction between the sidewall of the spinning wheel W and rolling member 21 will drive the power generating unit 2 to generate electrical current, which in turn powers the light unit 4. The power generating unit 2 thus serves as both a power source and an actuator for the light unit 4. Moreover, the instant brake system may include a voltage regulating device to protect the system from power surge and thereby increasing operational reliability. In addition, the brake system may utilize an electric charge storage device, such as a capacitor, to prolong the lighting effect of the light unit 4 upon the complete stopping of the bicycle wheel.

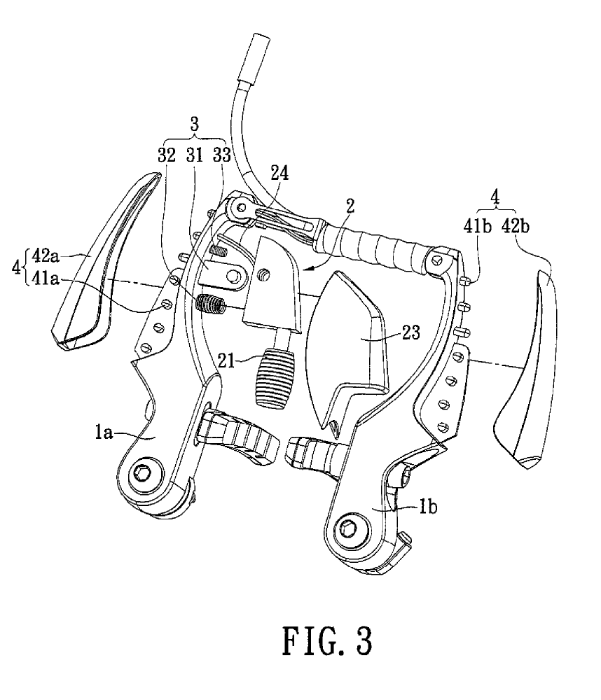

Please refer to FIG. 3, which shows an exploded diagram of a brake light system in accordance with the instant disclosure. The power generating unit 2 includes a rotary electric current generator (such as a dynamo) having a rolling member 21 disposed on the rotary shaft thereof. The power generating unit 2 is preferably adapted to a mounting member 31 that can be securely mounted on the brake arm 1a/1b of the brake system. As shown in the instant figure, the power generating unit 2 has a low profile housing member that can be pivotally mounted on a suitably designed mounting member 31 on the brake arm 1a. The power generating unit 2 is employed to harness the kinetic energy of the spinning bicycle wheel and to convert the mechanical energy into electrical current for powering to the light unit 4. The light unit 4 may be a physically separate unit arranged on suitable locations of the bicycle that is visible to the surrounding traffic, and preferably toward the rear portion of the bicycle frame. Nevertheless, the present embodiment incorporates a light unit 4 (having brake light modules 41a, 41b) as an integral part of the brake system. Specifically, the brake light module 41a/41b is integrally arranged an the brake arm 1a/1b and is enclosed by a conformal light shield member 42a/42b, respectively. Moreover, the light shield member 42a/42b incorporates conformal design to blend into the structural outline of the brake arm 1a/1b. This conformal and integrated arrangement of the instant brake light module 41a/41b on the brake arm 1a/1b not only decreases the distance between the light unit 4 and the power generating unit 2, thus reducing required wire length and the wiring complexity), it also offers a clean and neat appearance to the instant brake light system that boosts the unit's overall aesthetics.

The light unit 4 preferably employs energy efficient lighting elements that possess small physical signatures. Semiconductor light source such as light-emitting diode (LED) is a suitable choice for its energy efficiency, light weight, and small physical profile. Particularly, the instant embodiment utilizes a plurality of LED elements in the brake light modules 41a, 41b to increase visibility and create a uniform visual effect. The color of the light unit 4 is preferably red, conforming to the customary color for vehicle brake lights.

The power generating unit 2 is mounted on the brake arm 1a by a mounting mechanism 3. The mounting mechanism 3 comprises a mounting member 31 that is securely disposed on the brake arm 1a and a tensioning member 32 that provides tension to the power generating unit 2. Preferably, the mounting member 31 is designed to provide a firm yet non-rigid coupling of the power generating unit 2 to the brake arm 1a. The tensioning member 32 is arranged to bias the rolling member 21 of the power generating unit 2 toward the contact surface of the bicycle wheel. The firm but non-rigid setup facilitates the establishment of constant and continuous contact between the rolling member 21 and the bicycle wheel without interfering with inward movements of the brake arms during the operation of the brake system. Moreover, the tensioning member 32 of the mounting mechanism 3 can offer structural flexibility to cope with sudden shocks and instantaneous deformations that a wheel may encounter during the travel of the vehicle. For one thing, the instant embodiment utilizes a mounting mechanism that enables pivotally mounting of the power generating unit 2 onto the brake arm 1a. Constant and continuous contact with the bicycle wheel facilitates smooth rotation of the rolling member 21 thereby improving the efficiency of energy conversion. The energy conversion efficiency from the spinning bicycle wheel to the power generating unit 2 may be further enhanced through careful design of the shape of the rolling member 21. A particular example is shown in FIG. 2, in which a rolling member having a shape resembling a honey dipper is employed for establishing better frictional contact with the wheel. For one thing, the initial contact angle of the rolling member 21 with the wheel may not always be constant, as the power generating unit 2 is arranged on and pivots with the brake arm. Wheels of different width and radius may also affect the contact angle of the rolling member 21. The barrel shape of the rolling member 21 helps to provide better tangential contact with the bicycle wheel, therefore allowing proper contact between the rolling member 21 and the wheel at a wider range of angles and reducing the need for frequent angle adjustments to the power generating unit 2. Furthermore, the grooves on the sidewall of the rolling member 21 may contribute to the reduction of hydroplaning effect by channeling water or other fluids away from the contact surfaces, thus increasing grip of the rolling member 21 to the bicycle wheel. It is to be noted that, the specific groove pattern on the side surface of the rolling member 21 should depend on specific operational requirements and therefore should not be limited to the examples illustrated by the instant figures. For instance, a plurality of longitudinal grooves arranged substantially in the direction of the rotational axis of the rolling member 21 may be utilized to provide a wide contact area while retaining the water-channeling capability.

The tensioning member 32 may include an elastic component correspondingly arranged in cooperation with the mounting member 31 to provide biasing force to the housing of the power generating unit 2. The tensioning member 32 of the instant embodiment utilizes a coil spring as the elastic component. However, the choice of the elastic component should not be limited to the particular example provided herein. For example, other types of springs, such as V-springs or leaf springs, or even rubber/polyurethane bushings of proper elasticity may be suitable choices for the tensioning member 32, depending on specific design arrangements and/or particular operational requirements.

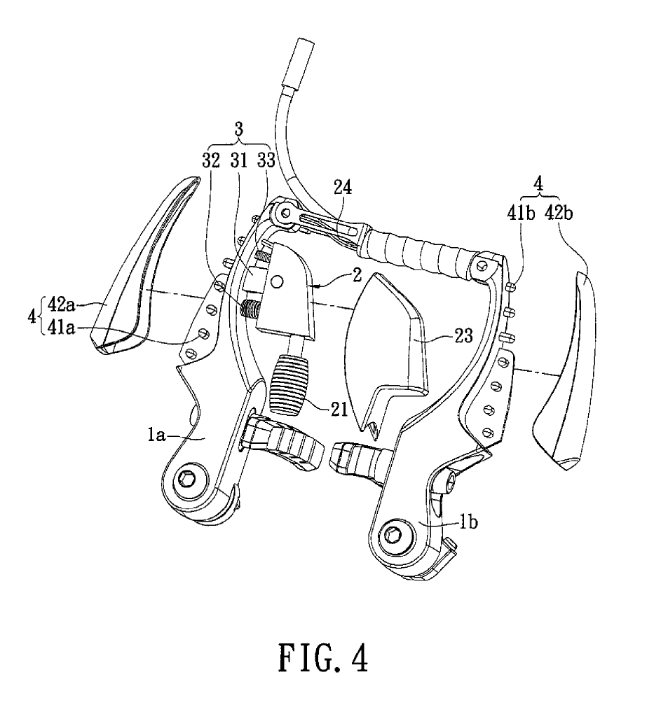

The mounting mechanism 3 may further include a sub-trim unit 33 for adjusting the position of the power generating unit 2 with respect to the bicycle wheel. Please refer to FIG. 4, which shows a partially exploded diagram of the brake light system in accordance with the instant disclosure with the power generating unit 2 mounted in place. Viewing from the particular angle illustrated by the instant figure, the power generating unit 2 is pivotally mounted on the brake arm 1a, while the rolling member 21 thereof is biased toward the bicycle wheel by the tensioning member 32 arranged on one side of the mounting member 31. The protruding sub-trim unit 33 is arranged on the other side of the mounting member 31 and serves as an adjustable stopping block for the power generating unit 2. The sub-trim unit 33 may be used to conveniently set up proper clearance between the rolling member 21 and the sidewall of the bicycle wheel. For instance, a less protruding sub-trim unit 33 setting will allow the rolling member 21 to seat closer to the bicycle wheel, while a more protruding sub-trim setting will push the rolling member 21 away from the contact surface of the bicycle wheel. Moreover, the sub-trim unit 33 may be used to fine tune the relative position of the rolling member 21 with respect to the rest of the brake components, particularly, the brake shoe. The advantage of the sub-trim unit 33 rests in the added convenience in adjusting of the position of the rolling member 21 with respect to the brake shoe to compensate for the wearing of the brake pad. For structural simplicity, the sub-trim unit 33 of the instant exemplary embodiment utilizes a set screw to provide adjustments to the position of the power generating unit 2 with respect to the arm portion of the brake system. However, other structural arrangements may be suitably improvised to provide similar adjustability.

A generator cover 23 is provided to protect the power generating unit 2 from surrounding hazards, such as water, dust, or mud. Specifically, the instant exemplary embodiment employs a conformal cover unit that blends in nicely with the contour of the brake arm and provides shielding for the power generating unit 2, revealing the rolling member 21 thereof for establishing frictional contact with the bicycle wheel.

As illustrated by the instant figures, the instant embodiment employs a single power generating unit 2 on one of the brake arms (1a) in an asymmetrical fashion. A cable 24 is utilized to conduct electrical power to the brake light module 41b of the light unit 4 on the opposing brake arm (1b). Specifically, the cable 24 is arranged across the brake arms 1a, 1b along the brake cable 12. Portions of the cable 24 coil around the brake cable 12 before being received by the flexible bellows 14. The arrangement provides the cable 24 enough slack to cope with the actuating movement of the brake arms. By using a single power generating unit 2 to power more than one brake light module, the asymmetrical design of the instant embodiment stresses the advantage of cost effectiveness over the structural concerns of cable wiring complexity. One the other hand, an alternative design may employ a pair of smaller and less powerful dynamo units, with each unit respectively arranged on each brake arm to power a brake light module. This setup gets rid of the need for the power cable 24 running across the brake arms, thereby reducing potential reliability issues resulting from cable breakage. Furthermore, if cost is of primary concern, the instant brake light system may adapt only one dynamo unit and one lighting module on a single brake arm to further simplify structural complexity at the possible cost of visibility and aesthetics.

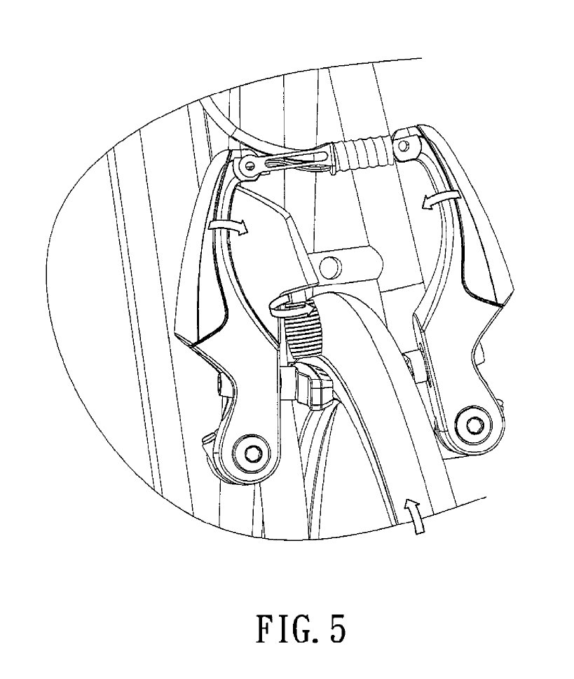

Finally, please refer to FIG. 5, which provides a graphical illustration of the actuation and the activation of the brake light system in accordance with the instant disclosure. As the rider operates the brake system of his/her rolling bicycle by pulling the brake handle, the force applied is transferred to the respective brake unit (in this case, the rear brake unit) through the brake cable 12, thereby pulling the brake arms 1a, 1b toward the bicycle wheel. The arrangement of the instant brake light system allows the rolling member 21 of the power generating unit 2 to establish frictional contact with the bicycle wheel at around the same time (and preferably, slightly before) as the brake pads of the Brake shoes 15a, 15b touching the wheel. The friction between the rolling wheel and the rolling member 21 drives the power generating unit 2, which in turn converts the kinetic energy of the rolling wheel into electric current that powers the brake light unit. The brake light unit, which employs energy efficient LEDs, requires only a small driving current (usually about 5 mA) to activate. Therefore, the instant disclosure provides a structurally reliable and self-sustaining solution for powering brake lights or other visual indicating devices on a human-powered vehicle.

While the invention has been disclosed with respect to a limited number of embodiments, numerous modifications and variations will be appreciated by those skilled in the art. It is intended, therefore, that the following claims cover all such modifications and variations that may fall within the true spirit and scope of the invention.

What is claimed is:

1. A brake light system for a human-powered vehicle having a frame and at least two wheels, comprising:
a brake arm mounted on the frame;
a power generating unit mounted on the brake arm including a rolling member for establishing frictional contact with the wheel; and
a light unit arranged on the brake arm and powered by the power generating unit.

2. The brake light system of claim 1, wherein the power generating unit is mounted on the brake arm through a mounting mechanism, the mounting mechanism comprising
a mounting member arranged on the brake arm, and
a tensioning member providing tension to the power generating unit for establishing frictional contact between the rolling member and the wheel.

3. The brake light system of claim 2, wherein the power generating unit is pivotally mounted on the mounting member.

4. The brake light system of claim 2, wherein the mounting mechanism further comprises a sub-trim unit for adjusting the position of the power generating unit relative to the wheel.

5. The brake light system of claim 4, wherein the sub-trim unit includes a set screw.

6. The brake light system of claim 2, wherein the tensioning member includes a coil spring.

7. The brake light system of claim 1, further comprising a generator cover conformally arranged on the brake arm covering the power generating unit.

8. The brake light system of claim 1, wherein the light unit is integrally arranged on the brake arm.

9. The brake light system of claim 8, further comprising a light shield unit conformally arranged on the brake arm covering the light unit.

10. The brake light system of claim 1, wherein the rolling member is of barrel shape and has at least one circumferential groove on the side surface thereof.

11. The brake light system of claim 1, wherein the rolling member is of barrel shape and has a plurality of longitudinal grooves arranged on the side surface thereof.

12. A brake light system for adapting to an arm portion of a brake system of a human-powered vehicle, comprising:
a mounting mechanism for secure adaptation to the arm portion of the brake system;
a power generating unit mounted on the mounting mechanism including a rolling member for establishing frictional contact with a wheel of the pedal-driven vehicle; and
a light unit arranged on the arm portion and powered by the power generating unit.

13. The brake light system of claim 12, wherein the mounting mechanism comprises
a mounting member for mounting the power generating unit onto the arm portion of the brake system,
a tensioning member providing tension to the power generating unit for establishing frictional contact between the rolling member and the wheel, and
a sub-trim unit for adjusting the position of the power generating unit relative to the wheel.

14. The brake light system of claim 13, wherein the power generating unit is pivotally mounted on the mounting member.

15. The brake light system of claim 13, wherein the tensioning member includes a coil spring.

16. The brake light system of claim 13, wherein the sub-trim unit includes a set screw.

17. The brake light system of claim 12, further comprising a generator cover conformally arranged on the arm portion and covering the power generating unit.

18. The brake light system of claim 12, wherein the light unit is integrally arranged on the arm portion of the brake system of the human-powered vehicle.

19. The brake light system of claim 18, further comprising a light shield unit conformally arranged on the arm portion covering the light unit.

20. The brake light system of claim 12, wherein the rolling member is of barrel shape and has at least one groove arranged on the side surface thereof.
